(19) United States
(12) Patent Application Publication
(10) Pub. No.: US 2012/0075410 A1
(43) Pub. Date: Mar. 29, 2012

(54) IMAGE PLAYBACK APPARATUS CAPABLE OF PLAYING BACK PANORAMIC IMAGE

(75) Inventors: Kosuke MATSUMOTO, Tokyo (JP); Naotomo Miyamoto, Tokyo (JP)

(73) Assignee: CASIO COMPUTER CO., LTD., Tokyo (JP)

(21) Appl. No.: 13/240,801

(22) Filed: Sep. 22, 2011

(30) Foreign Application Priority Data
Sep. 29, 2010 (JP) 2010-219473

(51) Int. Cl. H04N 7/00

(52) U.S. Cl. 348/36; 348/E05.022

(57) ABSTRACT

A digital camera 1 includes a storing unit 18, an orientation sensor 23, and an image playback unit 53. The storing unit 18 stores a panoramic image in association with orientation data indicative of shooting direction when capturing an image. The orientation sensor 23 acquires orientation data indicative of the direction of the image playback apparatus. The image playback unit 53 plays back an partial area of the panoramic image corresponding to the orientation data of the image playback apparatus, based on the orientation data in association with the panoramic image recorded by the storing unit 18, and the orientation data acquired by the orientation acquiring unit.

This application is based upon and claims the benefit of priority from Japanese Patent Application No. 2010-219473 filed on Sep. 29, 2010, the entire contents of which are incorporated herein by reference.

### BACKGROUND OF THE INVENTION

1. Field of the Invention

The present invention relates to an image playback apparatus, image playback method, and storage medium, and more particularly to an image playback apparatus, image playback method, and storage medium for playing back a panoramic image.

2. Related Art

Conventionally, digital cameras exist that have a function of capturing a wide landscape image (hereinafter referred to as “panoramic image”).

Japanese Patent Application Publication No. 1994-303562 discloses a technique, for example, that carries out image capture processing multiple times while a user is horizontally rotating the digital camera using his or her body as a rotation axis for a time period in which the user is continuously pressing down a shutter switch thereof and keeping the digital camera approximately fixed in a vertical direction.

The above-mentioned Patent Application Publication discloses a technique of generating image data for a panoramic image by combining, laterally (in a horizontal direction), image data of a plurality of images respectively obtained as a result of the multiple image capture processing.

It is an object of the present invention to playback a panoramic image such that scenery at a time of image capturing can be played back.

### SUMMARY OF THE INVENTION

In order to attain the above-described object, there is provided an image playback apparatus, comprising:

a recording unit that records data of a panoramic image in association with orientation data indicative of shooting direction at a time of image capturing;

an orientation acquiring unit that acquires orientation data indicative of the direction of the image playback apparatus; and

a playback unit that plays back a partial area of the panoramic image corresponding to the orientation data of the image playback apparatus, based on the orientation data in association with the panoramic image recorded by the recording unit, and the orientation data acquired by the orientation acquiring unit.

In order to attain the above-described object, there is provided an image playback apparatus, comprising:

a recording unit that records a panoramic image in association with angle data indicative of a tilt angle at a time of image capturing;

an angle acquiring unit that acquires angle data indicative of a tilt angle of the image playback apparatus; and

a playback unit that plays back a partial area of the panoramic image corresponding to the angle data of the image playback apparatus, based on the angle data in association with an image constituting the panoramic image recorded by the recording unit, and the angle data acquired by the angle acquiring unit.

### BRIEF DESCRIPTION OF THE DRAWINGS

FIG. 1 is a block diagram showing a hardware configuration of a digital camera as one embodiment of a playback apparatus according to the present invention;

FIG. 2 is a functional block diagram showing a functional configuration for the digital camera shown in FIG. 1 to carry out image capture processing and playback processing.

FIG. 3 is a set of diagrams respectively illustrating image capture operations in cases in which a normal image capture mode and a panoramic image capture mode are selected as an operation mode of the digital camera shown in FIG. 2;

FIG. 4 is a diagram showing one example of a panoramic image generated in the panoramic image capture mode shown in FIG. 3;

FIG. 5 is a top view showing a user's playback operation in a case in which panoramic playback mode is selected as a playback mode of the digital camera shown in FIG. 2;

FIG. 6 is a flowchart showing one example of flow of panoramic image capture processing carried out by the digital camera shown in FIG. 2;

FIG. 7 is a flowchart showing a detailed flow of panoramic image h processing from among the panoramic image capture processing of FIG. 6;

FIG. 8 is a flowchart showing a detailed flow of panoramic image generation and recoding processing of the panoramic image capture processing of FIG. 6; and

FIG. 9 is a flowchart showing one example of flow of panoramic playback processing carried out by the digital camera shown in FIG. 2.

### DETAILED DESCRIPTION OF THE INVENTION

The following describes an embodiment of the present invention with reference to the drawings.

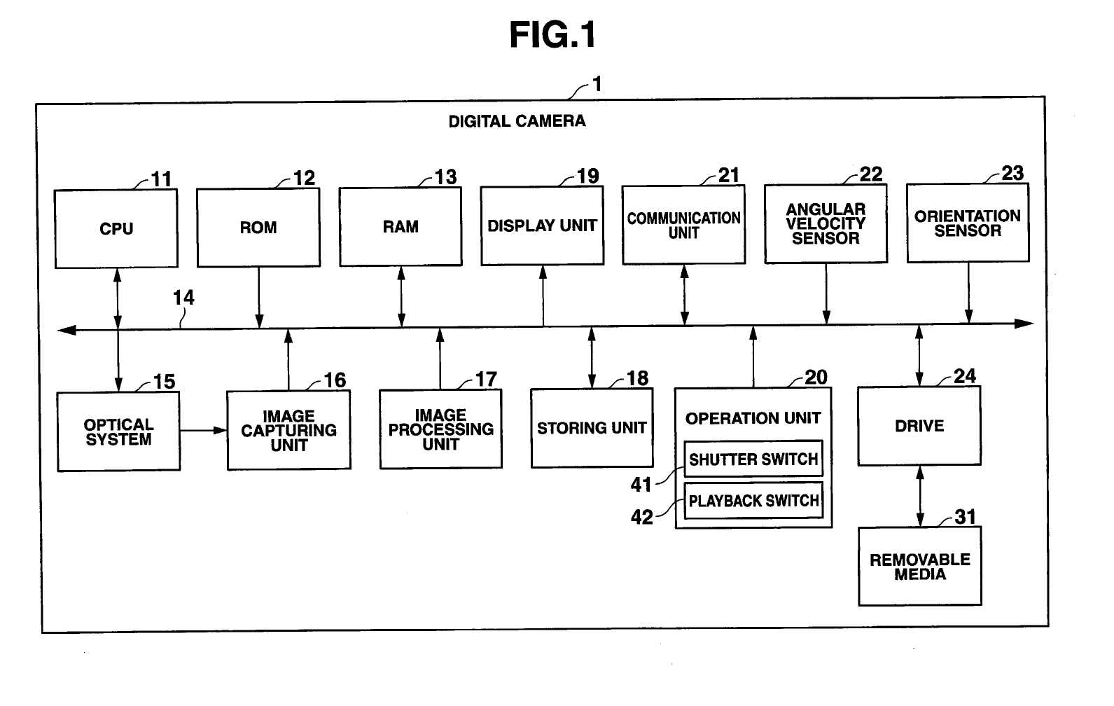

FIG. 1 is a block diagram showing a hardware configuration of a digital camera 1 as one embodiment of a recording apparatus and a playback apparatus according to the present invention.

The digital camera 1 is provided with a CPU (Central Processing Unit) 11, a ROM (Read Only Memory) 12, a RAM (Random Access Memory) 13, a bus 14, an optical system 15, an image capturing unit 16, an image processing unit 17, a storing unit 18, a display unit 19, an operation unit 20, a communication unit 21, an angular velocity sensor 22, an orientation sensor 23, and a drive 24.

The CPU 11 executes various processes according to programs that are stored in the ROM 12 or programs that are loaded from the storing unit 18 to the RAM 13.

The ROM 12 also stores data and the like, necessary for the CPU 11 to execute the various processes, as appropriate.

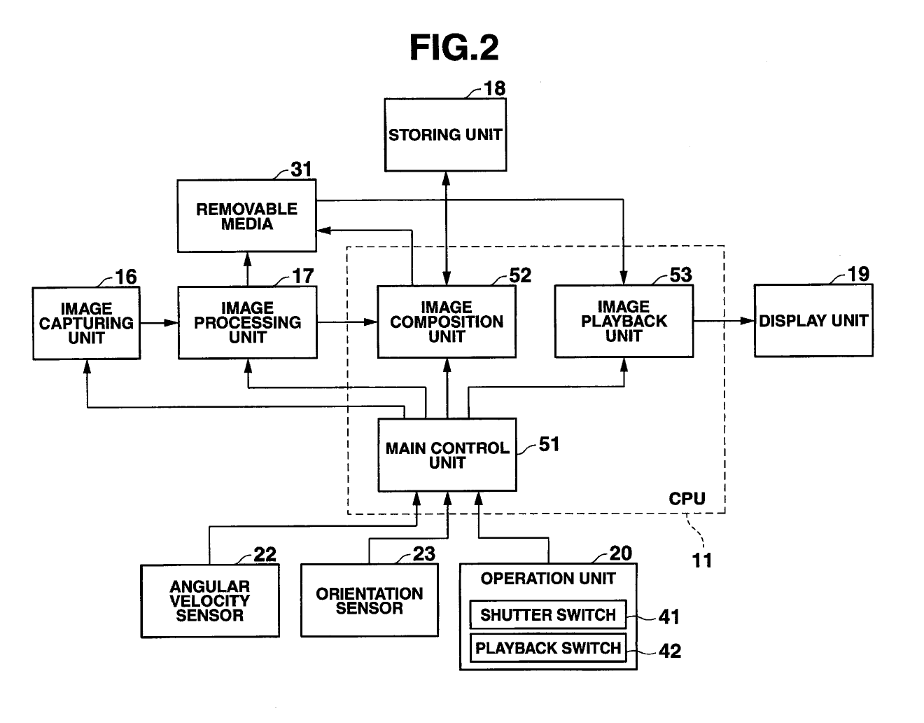

For example, according to the present embodiment, programs for implementing functions of a main control unit 51, an image composition unit 52, and an image playback unit 53 shown in FIG. 2, which will be described later, are stored in the ROM 12 or the storing unit 18. Therefore, each of the functions of the main control unit 51, the image composition unit 52, and the image playback unit 53 shown in FIG. 2, which will be described later, can be realized by the CPU 11 executing the processes according to these programs.

Incidentally, it is possible to transfer at least a part of each function of the main control unit 51, the image composition unit 52, and the image playback unit 53 shown in FIG. 2, which will be described later, to the image processing unit 17.

The CPU 11, the ROM 12, and the RAM 13 are connected to each other via the bus 14. The bus 14 is also connected with the optical system 15, the image capturing unit 16, the image processing unit 17, the storing unit 18, the display unit 19, the operation unit 20, the communication unit 21, the angular velocity sensor 22, the orientation sensor 23, and the drive 24.

The optical system 15 is configured by a light condensing lens such as a focus lens, a zoom lens, and the like, for example, to photograph a subject. The focus lens is a lens for forming an image of a subject on the light receiving surface of the image sensor of the image capturing unit 16. The zoom lens is a lens for freely changing a focal point within a predetermined range. The optical system 15 also includes a peripheral device to adjust focus, exposure, and the like, as necessary.

The image capturing unit 16 is configured by an optoelectronic conversion device, an AFE (Analog Front End), and the like. The optoelectronic conversion device is configured by a CCD (Charge Coupled Device) type or a CMOS (Complementary Metal Oxide Semiconductor) type optoelectronic conversion device, for example. The optoelectronic conversion device optoelectronically converts (i.e., captures), at a predetermined interval, a light signal of an image of a subject, which has been incident and accumulated during the interval, and sequentially supplies the resultant analog signal to the AFE.

The AFE executes various kinds of signal processing such as A/D (Analog/Digital) conversion on the analog signal and outputs the resultant digital signal as an output signal from the image capturing unit 16.

Hereinafter, the output signal from the image capturing unit 16 is referred to as “image data of a captured image”. Thus, image data of a captured image is outputted from the image capturing unit 16 and provided as appropriate to the image processing unit 17 and the like.

The image processing unit 17 is configured by a DSP (Digital Signal Processor), a VRAM (Video Random Access Memory), and the like.

The image processing unit 17 collaborates with the CPU 11 to execute various kinds of image processing such as noise reduction, white balance, and anti-shaking.

Hereinafter, image data of each captured image inputted from the image capturing unit 16 at a predetermined interval is referred to as “image data of a frame”. In the present embodiment, such image data of a frame is employed as a unit of processing. That is, the image processing unit 17 executes various kinds of image processing on image data of a frame provided from the image capturing unit 16 and outputs the resultant image data of the frame.

The storing unit 18 is configured by a DRAM (Dynamic Random Access Memory) and the like and temporarily stores the image data of a frame and the like outputted from the image processing unit 17. Also, the storing unit 18 stores various kinds of data necessary for various kinds of image processing.

The display unit 19 is configured as a flat display panel, for example, including LCD (Liquid Crystal Device) and LCD driving unit. The display unit 19 displays an image expressed by image data of a frame provided from the storing unit 18 or the like, e.g., live-view images, which will be described later, in units of frames.

The operation unit 20 includes a plurality of switches, as well as a shutter switch 41 and a playback switch 42, such as a power switch and an image capture mode switch though not shown. When one of the plurality of switches is pressed and operated, the operation unit 20 provides to the CPU 11 an instruction assigned to the switch.

The communication unit 21 controls communication with other devices (not shown) via networks including the Internet.

The angular velocity sensor 22 includes gyro and the like, detects an angular displacement of the digital camera 1, and provides to the CPU 11 the digital signal (hereinafter, simply referred to as “angular displacement”) indicative of the detection result.

The orientation sensor 23 includes an MI (Magneto-Impedance) element. The orientation sensor 23 detects dual axis (x, y) components of the geomagnetic field using the MI element, and outputs data indicative of the detection result. Hereinafter, data indicative of the detection result of the orientation sensor 23 is referred to as “orientation data”.

To the drive 24, removable media 31 such as a magnetic disk, an optical disk, a magneto-optical disk, or a semiconductor memory is mounted as appropriate. Also, programs read from the removable media 31 are installed in the storing unit 18 as necessary. Furthermore, similar to the storing unit 18, the removable media 31 may store various kinds of data such as image data and the like stored in the storing unit 18.

FIG. 2 is a functional block diagram showing a functional configuration for the digital camera 1 shown in FIG. 1, to carry out image capture processing and playback processing.

The image capture processing is intended to mean a series of processing to capture an image of a subject and storing in the removable media 31 the resultant image data of the captured image.

The playback processing is intended to mean a series of processing from read from the removable media 31 image data of a frame, to causing the display unit 19 to display the image expressed by the image data of the frame.

As shown in FIG. 2, the CPU 11 is provided with a main control unit 51, an image composition unit 52, and an image playback unit 53.

Incidentally, as described above, the functions of the main control unit 51, the image composition unit 52, and the image playback unit 53 are not necessarily installed in the CPU 11 as in the present embodiment, and it is possible to transfer at least a part of those functions to the image processing unit 17.

The main control unit 51 controls the overall execution of the image capture processing and the playback processing. For example, when controlling the execution of the image capture processing, the main control unit 51 can selectively switch the operation mode of the digital camera 1 between a normal image capture mode and a panoramic image capture mode, to execute processing in accordance with the operation mode after switching.

When switched to the panoramic image capture mode, the image composition unit 52 operates under the control of the main control unit 51.

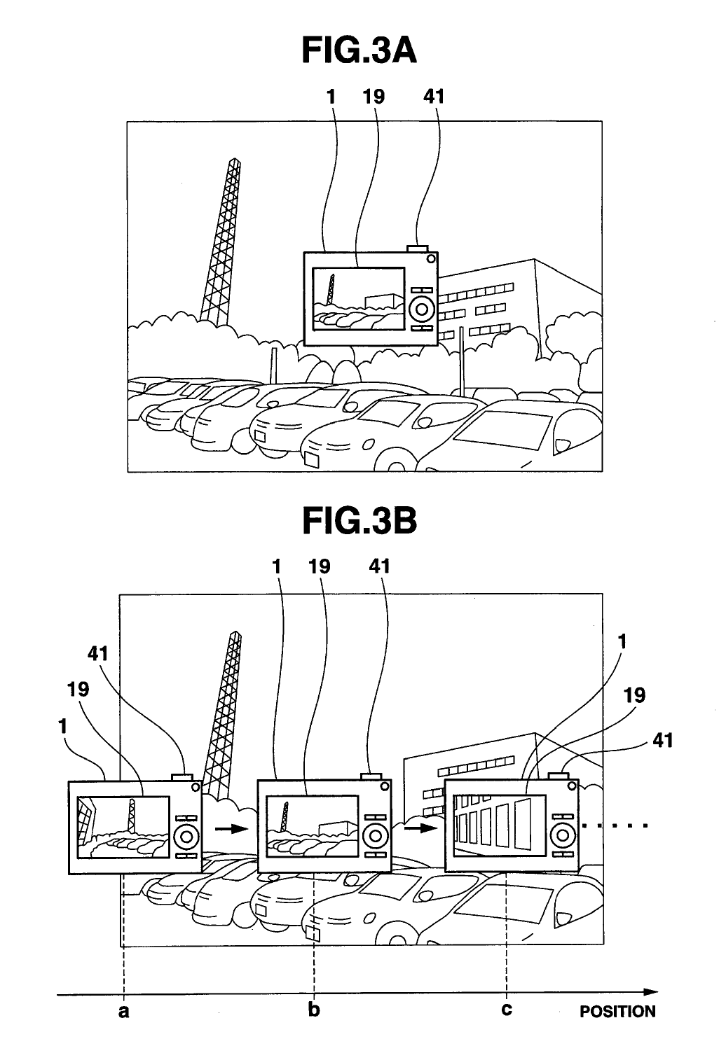

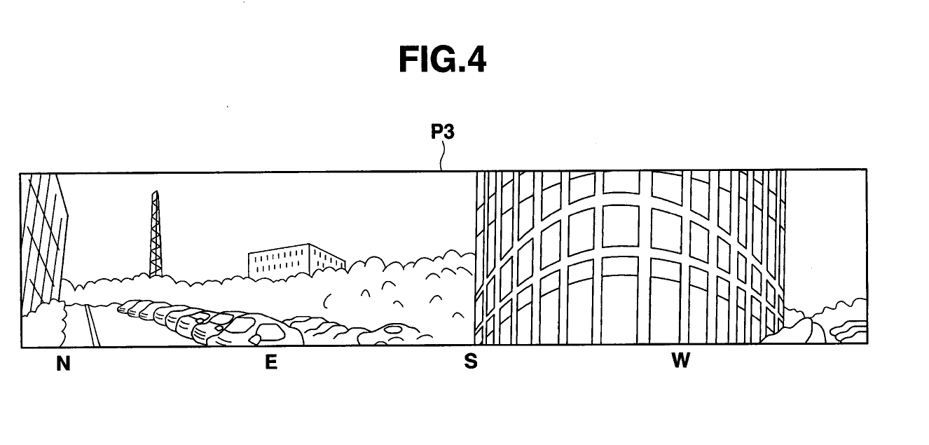

In the following, for ease of understanding of the main control unit 51 and the image composition unit 52, before describing functional configurations thereof a detailed description will be given of the panoramic image capture mode with reference to FIGS. 3 and 4 as appropriate.

FIG. 3 is a set of diagrams respectively illustrating image capture operations in cases in which the normal image capture mode and the panoramic image capture mode are selected as the operation mode of the digital camera 1 shown in FIG. 1.

More specifically, FIG. 3A is a diagram illustrating the image capture operation in the normal image capture mode. FIG. 3B is a diagram illustrating the image capture operation in the panoramic image capture mode.

In each of FIGS. 3A and 3B, the picture beyond the digital camera 1 shows a sight of the real world including the subject of the digital camera 1. The vertical dotted lines shown in FIG. 3B indicate positions a, b, and c in the moving direction of the digital camera 1. Here, the moving direction of the digital camera 1 is intended to mean a direction in which an optical axis of the digital camera 1 moves when the user pivots about his or her own body as an axis to change the direction (angle) of shooting of the digital camera 1.

The normal image capture mode is intended to mean an operation mode in which an image of a size (resolution) corresponding to the field of view of the digital camera 1 is captured.

In the normal image capture mode, as shown in FIG. 3A, the user, fixing the digital camera 1, presses the shutter switch 41 of the operation unit 20 all the way down. Hereinafter, such an operation of pressing the shutter switch 41 all the way down is referred to as “full press operation” or simply “full press”.

The main control unit 51 controls execution of a series of processing up to storing as a target to be recorded in the removable media 31 the image data of the frame outputted from the image processing unit 17 immediately after the user's full press operation.

Hereinafter, such a series of processing carried out under the control of the main control unit 51 in the normal image capture mode is referred to as “normal image capture processing”.

On the other hand, the panoramic image capture mode is intended to mean an operation mode in which a panoramic image is captured.

In the panoramic image capture mode, as shown in FIG. 3B, the user moves the digital camera 1 in the direction of the black arrows shown therein maintaining the full press operation of the shutter switch 41.

While the full press operation is maintained, the main control unit 51 controls the image composition unit 52 and the like. The main control unit 5 repeats temporarily storing in the storing unit 18 the image data of a frame outputted from the image processing unit 17 immediately after each time an angular displacement cumulatively provided from the angular velocity sensor 22 reaches a constant value.

After that, the user instructs to terminate the capturing of a panoramic image by way of an operation of releasing the full press operation (hereinafter, referred to as “release operation”), i.e., pulling a finger or the like away from the shutter switch 41.

When instructed to terminate the capturing of a panoramic image, the main control unit 51 generates data of a panoramic image by horizontally combining image data of the plurality of frames thus far stored in the storing unit 18 in the stored order.

And then, the main control unit controls the image composition unit 52 and the like to store the data of the panoramic image in the removable media 31 as a target to be recorded.

Thus, in the panoramic image capture mode, the main control unit 51 controls the image composition unit 52 and the like, and thus controls a series of processing from generating data of a panoramic image up to storing it in the removable media 31 as a target to be recorded.

Hereinafter, such a series of processing in the panoramic image capture mode carried out under the control of the main control unit 51 is referred to as “panoramic image capture processing”.

This means that the image composition unit 52 executes the following processing under the control of the main control unit 51.

This means that the image composition unit 52 receives an acquisition instruction issued from the main control unit 51 each time the digital camera 1 moves by a predetermined amount (each time the cumulative value of the angular displacement reaches a constant value). Following the acquisition instruction, the image composition unit 52 acquires image data of one frame from the image processing unit 17, and stores the image data in the storing unit 18.

At this time of acquiring image data of each frame, the image composition unit 52 acquires orientation data indicative of the current orientation of the optical axis for shooting from the orientation sensor 23.

The image composition unit 52 generates data of a panoramic image by combining thus acquired image data of the plurality of frames and stores it in the removable media 31. At this time, the image composition unit 52 stores at least a part of the orientation data thus far acquired in the removable media 31 associating with the data of the panoramic image.

More specifically, in the present embodiment, data of a panoramic image is included in a predetermined file of an Exif (Exchangeable Image File Format) format. Hereinafter, such a file including data of a panoramic image is referred to as “panorama file”. The panorama file can include various kinds of meta information as well as data of a panoramic image.

In the present embodiment, at least a part of the orientation data acquired when capturing a panoramic image is included in a panorama file as a kind of the meta information, and such a panorama file is stored in the removable media 31.

In the present embodiment, while capturing a panoramic image, image data of a frame to be combined is acquired each time the cumulative value of the angular displacement of the digital camera 1 reaches a constant value. Therefore, if at least one item of the orientation data is acquired along with the image data of a frame, for example, the first frame, it is possible to estimate the orientation corresponding to each of respective horizontal positions of frames of the panoramic image.

On the other hand, obviously, the more items of orientation data are acquired, the more accurately the orientation corresponding to each horizontal position of the panoramic image can be specified.

Therefore, the number of items of orientation data included in a panorama file as meta information may be any number.

FIG. 4 shows one example of a panoramic image generated by the image composition unit 52 in the panoramic image capture mode shown in FIG. 3.

When an image capture operation shown in FIG. 3B is performed in the panoramic image capture mode, the image composition unit 52 generates data of a panoramic image P3 shown in FIG. 4 and stores it in the removable media 31 under the control of the main control unit 51.

The data of the panoramic image P3 is stored in the removable media 31 associated with the orientation data for each image area corresponding to each composed frame of the panoramic image P3.

With this, it becomes possible to easily recognize which horizontal position of the panoramic image P3 corresponds to each of the orientations of N (North), E (East), S (South), and W (West), as shown in FIG. 4.

In the above, a description has been given of the functional configuration to carry out the image capture processing from among the functional configuration of the digital camera 1 of FIG. 2.

In the following, a description will be given of the functional configuration of the digital camera 1 to carry out the playback processing.

The playback processing is executed by the image playback unit 53 under the control of the main control unit 51.

Regarding the control of the execution of the playback processing, the main control unit 51 can selectively switch between a normal playback mode and a panoramic playback mode as the operation mode of the digital camera 1. Then, the main control unit 51 can execute processing in accordance with the operation mode after switched.

The normal playback mode is intended to mean a mode in which image data of a captured image acquired in the normal image capture mode or image data of the same size (resolution) as such a captured image is played back.

The panoramic playback mode is intended to mean a mode in which data of a panoramic image captured in the panoramic image capture mode or a panoramic image acquired from another device or storage medium is played back.

When the panoramic playback mode is selected, the image playback unit 53 operates under the control of the main control unit 51.

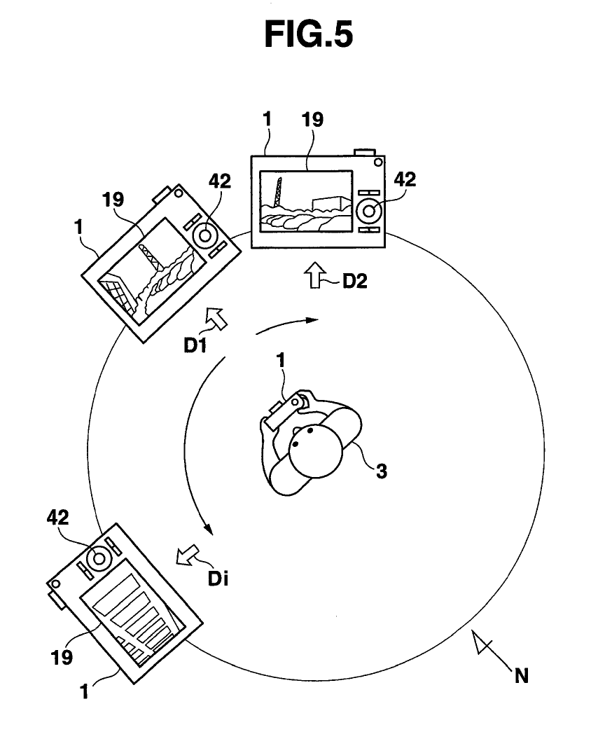

FIG. 5 is a top view showing a user's playback operation in a case in which the panoramic playback mode is selected as the operation mode of the digital camera 1 shown in FIG. 2.

In the panoramic playback mode of the present embodiment, from a panoramic image to be played back, an image area corresponding to the orientation of the digital camera 1 (the orientation of the optical axis from the inside to the outside of the digital camera 1) is displayed.

In a case of a digital camera 1, in which the direction of the optical axis of the image capturing unit 16 for shooting is different from an orientation of the direction of the eyes of the user toward the display screen of the display unit 19, as an orientation of the digital camera 1, the orientation of the direction of the eyes of the user toward the display screen of the display unit 19 is employed.

Therefore, as shown in FIG. 5, as a user rotationally moves the digital camera 1 in a similar manner to when a panoramic image was captured, the display content is sequentially updated to show an image area corresponding to the orientation to which the digital camera 1 is directed, which is changed after the digital camera 1 is moved.

Here, “the image area corresponding to the orientation which the digital camera 1 is directed to” is intended to mean an image area in the vicinity of the position corresponding to the orientation from among horizontal positions of a panoramic image, i.e., the image area facing toward and captured in the field of view of the digital camera 1 directed in the same orientation as when the panoramic image was captured.

For example, in a case in which the panoramic image P3 in FIG. 4 is to be played back and the digital camera 1 is directed toward the direction D1 in FIG. 5, i.e., N (North), from the panoramic image P3, an image area is displayed such that the horizontal position thereof corresponds to N (North).

After that, when the digital camera 1 rotationally moves and is directed in the direction D2 in FIG. 5, i.e., North-East, from the panoramic image P3, an image area is displayed such that the horizontal position thereof corresponds to North-East (the orientation in between North and East).

A similar result is acquired when the digital camera 1 rotationally moves in the opposite direction. That is, when the digital camera 1 rotationally moves and is directed toward the direction Di in FIG. 5, i.e., W (West), from the panoramic image P3, an image area is displayed such that the horizontal position thereof corresponds to W (West).

In order to enable this type of display of a panoramic image, the image playback unit 53 acquires orientation data (included in the panorama file as an item of meta information in the present embodiment) that is stored in association with the panoramic image to be played back under the control of the main control unit 51.

Hereinafter, such orientation data is referred to as “index orientation data”, since the orientation data can be an index to identify an orientation corresponding to a horizontal position of a panoramic image as described above.

Here, the orientation data acquired as the index orientation data may be all orientation data that has been stored in association with the data of the panoramic image, or may be a part of the orientation data.

When data of a panoramic image to be played back is included in a panorama file stored in the removable media 31, at least a part of the orientation data included as meta information in the panorama file is acquired as the index orientation data.

The image playback unit 53 acquires, as orientation data indicative of the current orientation (pointing direction) of the digital camera 1, orientation data indicative of a direction of an optical axis of the image capturing unit 16 for shooting or a direction from which a screen of the display unit 19 can be seen is acquired from the orientation sensor 23 under the control of the main control unit 51. Hereinafter, the orientation data indicative of the current orientation of the digital camera 1 is referred to as “current orientation data”.

The image playback unit 53 extracts data of an image area corresponding to the current orientation from the data of the panoramic image to be played back using the index orientation data and the current orientation data. Then, the image playback unit 53 causes the display unit 19 to display the image expressed by the extracted image data under the control of the main control unit 51.

In this way, in the panoramic playback mode, the image playback unit 53 controls a series of processing up to causing the display unit 19 to display the panoramic image, data of which is stored in the removable media 31 or the like, under the control of the main control unit 51.

Hereinafter, the series of processing executed by the image playback unit 53 in the panoramic playback mode is referred to as “panoramic playback processing”.

As described above, for whichever direction the user rotationally moves the digital camera 1, it is possible to cause the display unit 19 to display an image area corresponding to the current orientation of the digital camera 1 from the panoramic image to be played back. Therefore, the user can view the panoramic image with a sense that the scenery is spreading out at a place where the panoramic image was captured.

In the above, a description has been given of the functional configuration of the digital camera 1 of the present embodiment with reference to FIGS. 2 to 5.

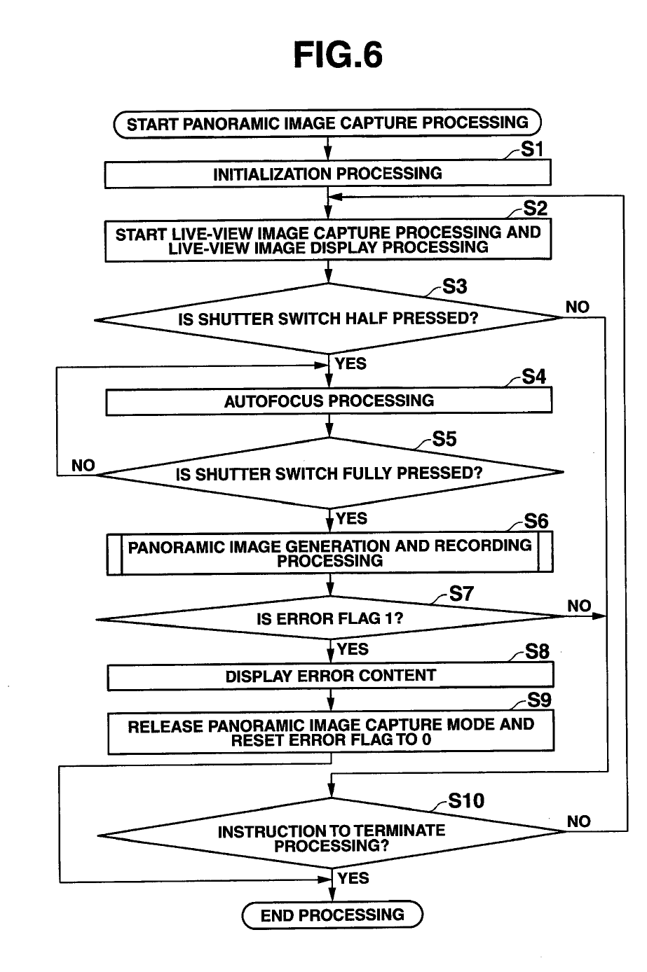

In the following, a description will be given of flow of the panoramic image capture processing among the image capture processing carried out by the digital camera 1 having such a functional configuration with reference to FIG. 6.

FIG. 6 is a flowchart showing one example of flow of the panoramic image capture processing.

In the present embodiment, the panoramic image capture processing starts when the panoramic image capture mode is set.

In step S1, the main control unit 51 shown in FIG. 2 executes initialization processing.

In the present embodiment, the initialization processing includes processing of setting a constant value of the angular displacement and a threshold value (e.g., 360 degrees) as an upper limit of the angular displacement.

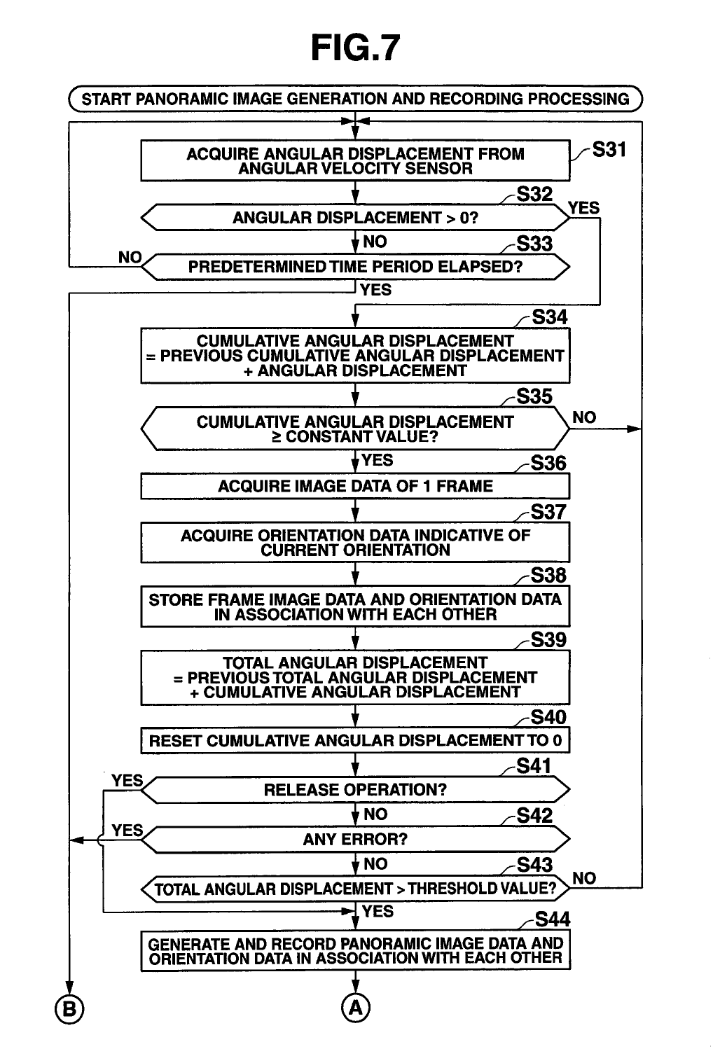

More specifically, the constant value of angular displacement and the threshold value (e.g., 360 degrees) as upper limit of angular displacement are stored in advance in the ROM 12 of FIG. 1. Setting thereof is carried out by reading from the ROM 12 and writing into the RAM 13 those values. The constant value of angular displacement is for use in the determination process of step S35 of FIG. 7, which will be described later. On the other hand, the threshold value (e.g., 360 degrees) as an upper limit of the angular displacement is for use in the determination process of step S43 of FIG. 7.

Furthermore, in the present embodiment, an angular displacement detected by the angular velocity sensor 22 is accumulatively added as shown in steps S34, S39, and the like of FIG. 7, which will be described later. As a result of accumulation thereof, a cumulative angular displacement and a total angular displacement are stored in the RAM 13. The difference between the cumulative angular displacement and the total angular displacement will be described later. Therefore, processes of resetting the cumulative angular displacement and the total angular displacement to 0 are included in the initialization processing in the present embodiment. The cumulative angular displacement is compared with the above-described constant value in the determination process of step S35 of FIG. 7, which will be described later. On the other hand, the total angular displacement is compared with the above-described threshold value in the determination process of step S43 of FIG. 7, which will be described later.

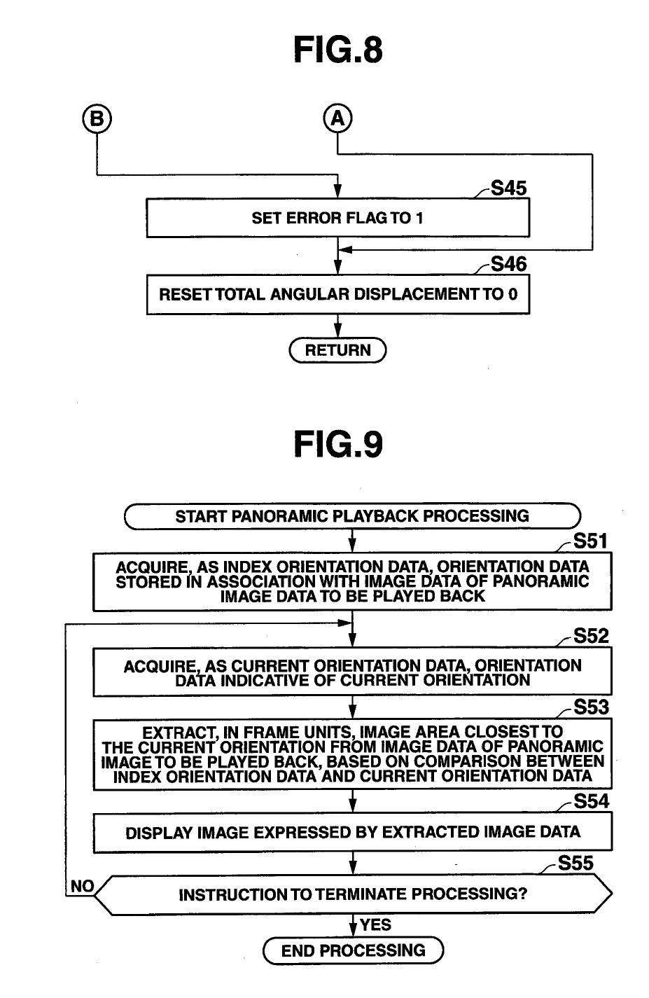

Furthermore, the initialization processing in the present embodiment includes a process of resetting an error flag to 0. The error flag is intended to mean a flag that is set to 1 when an error occurs during the panoramic image generation and recording processing (see step S45 of FIG. 8, which will be described later).

In step S2, the main control unit 51 starts live-view image capture processing and live-view image display processing.

The main control unit 51 controls the image capturing unit 16 and the image processing unit 17 to continue image capture operation by the image capturing unit 16. While the image capture operation is continued by the image capturing unit 16, the main control unit 51 temporarily stores in a memory (the storing unit 18, in the present embodiment) image data of frames outputted from the image capturing unit 16 via the image processing unit 17. Such a series of control processing by the main control unit 51 is what is referred to as “live-view image capture processing”.

Also, the main control unit 51 controls a display control unit (not shown) to sequentially read image data temporarily stored in the memory (the storing unit 18, in the present embodiment) at the time of live-view image capturing. Then, the main control unit 51 sequentially displays frame images corresponding to respective pieces of the thus read image data on the display unit 19. Such a series of control processing by the main control unit 51 is what is referred to as “live-view image display processing”. Hereinafter, the frame image displayed on the display unit 19 by the live-view image display processing is referred to as “live-view image”.

In step S3, the main control unit 51 determines whether or not the shutter switch 41 is half pressed.

Here, “half press” is intended to means an operation to press the shutter switch 41 of the operation unit 20 half way down (as far as a predetermined position but short of its lower limit). Hereinafter, such operation is referred to as “half press operation” as appropriate.

If the shutter switch 41 is not half pressed, NO is determined in step S3, and control proceeds to step S10.

In step S10, the main control unit 51 determines whether or not it is instructed to terminate the processing.

In the present embodiment, it is assumed that, as the instruction to terminate the processing, notification is used which indicates that the power supply (not shown) of the digital camera 1 has been turned off, though the instruction to terminate the processing is not particularly limited thereto.

Therefore, in the present embodiment, when the main control unit 51 is notified that the power supply has been turned off, YES is determined in step S10, and the entire panoramic image capture processing ends.

On the other hand, when the power supply is on, since power off state has not been notified, NO is determined in step S10, control goes back to step S2, and the processes thereafter are repeated. This means that, in the present embodiment, as long as the power is on, the loop processing from steps S3: NO, to S10: NO, is repeated until the shutter switch 41 is half pressed, and the panoramic image capture processing enters into a waiting state.

During such live-view image display processing, when the shutter switch 41 is half pressed, YES is determined in step S3, and control proceeds to step S4.

In step S4, the main control unit 51 controls the image capturing unit 16 to execute what is called AF (Auto Focus) processing.

In step S5, the main control unit 51 determines whether or not the shutter switch 41 is full pressed.

If the shutter switch 41 is not full pressed, NO is determined in step S5. In this case, control goes back to step S4, and the processes thereafter are repeated. In the present embodiment, until the shutter switch 41 is full pressed, the loop processing of steps S4 and S5: NO is repeated, and the AF processing is executed for each time.

After that, when the shutter switch 41 is full pressed, YES is determined in step S5, and control proceeds to step S6.

In step S6, the main control unit 51 executes a series of processing (hereinafter, referred to as “panoramic image generation and recording processing”) from generating image data of a panoramic image up to storing it in the removable media 31, in principle.

A detailed description of the panoramic image generation and recording processing will be given with reference to FIGS. 7 and 8.

When the panoramic image generation and recording processing of step S6 ends, control proceeds to step S7.

In step S7, the main control unit 51 determines whether or not the error flag is set to 1.

Though the detailed description will be given later with reference to FIGS. 7 and 8, if the image data of the panoramic image is stored in the removable media 31 as a recording target and thereby the panoramic image generation and recording processing of step S6 properly ends, the error flag is set to 0. In such a case, NO is determined in step S7, and control proceeds to step S10. Since the processes of steps S10 and after have been already described in the above, the description thereof is omitted here.

On the other hand, if some error has occurred during the panoramic image generation and recording processing of step S6, the panoramic image generation and recording processing ends. In such a case, since the error flag is set to 1, YES is determined in step S7, and control proceeds to step S8.

In step S8, the main control unit 51 displays the error content on the display unit 19. Specific examples of the error content to be displayed will be described later.

In step S9, the main control unit 51 releases the panoramic image capture mode and resets the error flag to 0.

With this, the entire panoramic image capture processing ends.

In the above, a description has been given of flow of the panoramic image capture processing with reference to FIG. 6.

In the following, a description will be given of a detailed flow of the panoramic image generation and recording processing of step S6 from the image capture processing of FIG. 6 with reference to FIGS. 7 and 8.

FIGS. 7 and 8 are flowcharts showing a detailed flow of the panoramic image generation and recording processing.

As described above, when the shutter switch 41 is full pressed in the panoramic image capture mode, YES is determined in step S5 of FIG. 6, control proceeds to step S6, and the following processing is executed as the panoramic image generation and recording processing.

This means that, in step S31 of FIG. 7, the main control unit 51 acquires angular displacement from the angular velocity sensor 22.

In step S32, the main control unit 51 determines whether or not the angular displacement acquired in the process of step S31 is greater than 0.

If the user has not moved the digital camera 1, since the angular displacement is 0, NO is determined in step S32, and control proceeds to step S33.

In step S33, the main control unit 51 determines whether or not a predetermined time period for which the angular displacement continues to be 0 has elapsed. As the predetermined time period, for example, a time period can be employed that is appropriately longer than a time period necessary for the user to start to move the digital camera 1 after the full press of the shutter switch 41.

If the predetermined time period has not elapsed, NO is determined in step S33. Then, control goes back to step S31, and the processes thereafter are repeated. As long as the duration of a state in which the user does not move the digital camera 1 does not exceed the predetermined time, the main control unit 51 repeats the loop processing from steps S31 to S33: NO, and thereby the panoramic image generation and recording processing enters into a waiting state.

In such a waiting state, if the user moves the digital camera 1, the angular displacement supplied from the angular velocity sensor 22 becomes greater than 0. In such a case, YES is determined in step S32, and control proceeds to step S34.

In step S34, the main control unit 51 updates the cumulative angular displacement by adding the angular displacement acquired in the process of step S31 to the previous cumulative angular displacement (cumulative angular displacement=previous cumulative angular displacement+angular displacement). In this way, the value stored in the RAM 13 as the cumulative angular displacement is updated.

The cumulative angular displacement is intended to mean such an accumulated value of the angular displacement and indicates the moving amount of the digital camera 1.

Here, in the present embodiment, each time the user moves the digital camera 1 by a predetermined amount, it is assumed that image data of one frame (composition target) for generation of image data of a panoramic image is supplied from the image processing unit 17 to the image composition unit 52.

For this purpose, a cumulative angular displacement corresponding to the “predetermined amount” as moving amount of the digital camera 1 has been given in advance as the “constant value” in the initialization processing of step S1 of FIG. 6.

In the present embodiment, each time the cumulative angular displacement reaches the constant value, image data of one frame (composition target) is supplied from the image processing unit 17 to the image composition unit 52, and the cumulative angular displacement is reset to be 0.

Such a series of processing is carried out as processes of a subsequent step S35 and thereafter.

In step S35, the main control unit 51 determines whether or not the cumulative angular displacement has reached the constant value.

If the cumulative angular displacement has not yet reached the constant value, NO is determined in step S35, control goes back to step S31, and processes thereafter are repeated. This means that until the cumulative angular displacement has reached the constant value due to the fact that the user has moved the digital camera 1 by the predetermined amount, the main control unit 51 repeats the loop processing from steps S31 to S35.

After that, when the cumulative angular displacement has reached the constant value due to the fact that the user has moved the digital camera 1 by the predetermined amount, YES is determined in step S35, and control proceeds to step S36.

In step S36, the image composition unit 52 acquires image data of one frame from the image processing unit 17 under control of the main control unit 51.

This means that after control proceeds to step S36 due to the fact that the cumulative angular displacement has reached the constant value, the main control unit 51 issues an acquisition instruction to the image composition unit 52.

Upon receiving the acquisition instruction, the image composition unit 52 acquires image data of one frame from the image processing unit 17, as the process of step S36.

In step S37, the main control unit 51 acquires orientation data indicative of the current orientation from the orientation sensor 23.

In step S38, the main control unit 51 temporarily stores in the storing unit 18 or the like the image data of one frame acquired in the process of step S36 and the orientation data acquired in the process of step S37 in association with each other.

In step S39, the main control unit 51 updates the total angular displacement by adding the current cumulative angular displacement, which is approximately equal to the constant value, to the previous total angular displacement (total angular displacement=previous total angular displacement+cumulative angular displacement). In this way, the value stored in the RAM 13 as the total angular displacement is updated.

In step S40, the main control unit 51 resets the cumulative angular displacement to 0. This means that the value stored in the RAM 13 as the cumulative angular displacement is updated to 0.

In this way, the cumulative angular displacement is used for controlling the timing of the image data of one frame (composition target) being supplied from the image processing unit 17 to the image composition unit 52, i.e., the timing of issuing the acquisition instruction. For this purpose, the cumulative angular displacement is reset to 0 each time the constant value is reached and the acquisition instruction is issued.

Accordingly, even if the cumulative angular displacement is used, the main control unit 51 cannot recognize up to which position the digital camera 1 has moved from the panoramic image generation and recording processing starting up until the present.

In order to make it possible for the main control unit 51 to recognize up to which position the digital camera 1 has moved, in the present embodiment, the total angular displacement is employed in addition to the cumulative angular displacement.

The total angular displacement is an accumulated value of the angular displacement. However, the total angular displacement is not reset to 0 even if the cumulative angular displacement has exceeded the predetermined amount, and is always accumulatively added until the panoramic image generation and recording processing ends (more precisely, until the process of step S46, which will be described later, is executed).

After the total angular displacement is updated in the process of step S39 and the cumulative angular displacement is reset to 0 in the process of step S40, control proceeds to step S41.

In step S41, the main control unit 51 determines whether or not a release operation has been performed.

If no release operation has been performed, i.e., if the shutter switch 41 is still full pressed by the user, NO is determined in step S41, and control proceeds to step S42.

In step S42, the main control unit 51 determines whether or not any error has occurred in image capturing.

While error in image capturing is not particularly limited, in the present embodiment, as an error in image capturing, for example, any movement of the digital camera 1 in an oblique, upward, downward, or reverse direction by more than a predetermined value is employed.

If no error in image capturing has occurred, NO is determined in step S42, and control proceeds to step S43.

In step S43, the main control unit 51 determines whether or not the total angular displacement has exceeded the threshold value.

As described above, the total angular displacement is intended to mean an accumulated value of angular displacement from the start of the panoramic image generation and recording processing (when full press operation has been performed) until the process of step S39 is executed.

In the present embodiment, the maximum possible amount by which the user can move the digital camera 1 during the panoramic image capturing is predetermined. The total angular displacement corresponding to the “maximum moving amount” as moving amount of the digital camera 1 has been given in advance as the “threshold value” in the initialization processing of step S1 of FIG. 6.

This means that, in the present embodiment, the fact that the total angular displacement has reached the threshold value is that the digital camera 1 has moved by the maximum moving amount.

Therefore, if the total angular displacement has not reached the threshold value, i.e., the moving amount of the digital camera 1 has not reached the maximum moving amount, the user can still continue to move the digital camera 1. In this case, NO is determined in step S43, control goes back to step S31, and processes thereafter are repeated.

Assuming that a state in which the time period for which the angular displacement continues to be zero reaches a predetermined time period (the digital camera 1 has not moved for the predetermined time period) is included as one error in image capturing, as long as the full press operation continues in a state in which no error has occurred, the loop processing from steps S31 to S43 is repeated.

After that, in a state in which no error has occurred, if release operation is performed (i.e., YES is determined in the process of step S41) or when the digital camera 1 has moved beyond the maximum moving amount (i.e., YES is determined in the process of step S43), then control proceeds to step S44.

In step S44, the main control unit 51 generates image data of a panoramic image via the image composition unit 52 and stores it in the removable media 31 in association with at least a part of thus far acquired orientation data.

More specifically, the main control unit 51 stores coordination information of each of image areas constituting the panoramic image and orientation data corresponding to each of the image areas in the removable media 31 so as to be contained in the panorama file.

This means that the panorama file containing image data of a panoramic image and, as a part of meta information, a number of pieces of orientation data is stored in the removable media 31.

In step S46 of FIG. 8, the main control unit 51 resets the total angular displacement to 0.

With this, the panoramic image generation and recording processing properly ends. This means that the process of step S6 in FIG. 6 properly ends, and NO is determined in the process of the next step S7. Since the processes after NO is determined in the process of step S7 have been already described above, the description thereof is omitted here.

During the series of processing described above, if some error has occurred, i.e., if YES is determined in the process of step S33 of FIG. 7, or if YES is determined in the process of step S42, then control proceeds to step S45 of FIG. 8.

In step S45, the main control unit 51 sets the error flag to 1.

In this case, the process of step S44 is not executed, i.e., no image data of any panoramic image is recorded, and the panoramic image generation and recording processing ends.

This means that the process of step S6 of FIG. 6 ends, YES is determined in the process of the next step S7, and error content is displayed in the process of step S8.

What is displayed as error content in this case is not limited as described above. As error content, for example, a message such as “Orientation data acquisition failure” or “Time is over” may be displayed.

In the above, a description has been given of a detailed flow of the panoramic image capture processing with reference to FIGS. 6 to 8.

By carrying out such panoramic image capture processing one or more times, one or more panorama files are stored in the removable media 31. The panorama files contain image data of captured panoramic images and, as an item of meta information, orientation data acquired when the respective panoramic images are captured.

In this case, under control of the main control unit 51, one of the one or more panorama files is selected as a playback target, and the image playback unit 53 can play back the image data of the panoramic image (hereinafter, referred to as “playback target panoramic image”) contained in the panorama file selected as the playback target.

In the following, a description will be given of flow of the panoramic playback processing that enables this type of playback with reference to FIG. 9.

FIG. 9 is a flowchart showing one example of flow of the panoramic playback processing.

In the present embodiment, the panoramic playback processing starts when the panoramic playback mode is set. In the present embodiment, it is assumed, for ease of description, that the playback target panoramic image has been selected in advance by a user's selection operation of the operation unit 20.

In step S51, the image playback unit 53 shown in FIG. 2 acquires, as index orientation data, orientation data that has been stored in association with the coordination information corresponding to each of image areas constituting the playback target panoramic image as meta information of the panoramic file, from the removable media 31 or the like.

In step S52, the image playback unit 53 acquires, as the current orientation data, orientation data indicative of the current orientation, from the orientation sensor 23.

That is, the image playback unit 53 acquires the orientation (pointing direction) of the digital camera 1 as the current orientation of the eyes of the user, who is holding the digital camera 1.

In step S53, the image playback unit 53 compares the index orientation data acquired in the process of step S51 and the data of the current orientation acquired in the process of step S52. Then, the image playback unit 53 extracts data of an image area having the index orientation data closest to the data of the current orientation.

This means that the image playback unit 53 extracts data of an image area having an orientation equivalent to the current orientation of the user's eyes from the image data of the panoramic image.

In step S54, the image playback unit 53 causes the display unit 19 to display the image expressed by thus extracted data of the image area.

The image displayed on the display unit 19 at this time is scenery that has been viewed and captured in an orientation that is the same as the current user's eyes at a location where the panoramic image has been captured. Thus, it becomes possible to virtually present the scenery at the location at which the panoramic image was captured, at the present position where the user stands.

In step S55, the image playback unit 53 determines whether or not an instruction has been given to terminate the processing.

In the present embodiment, it is assumed that, with regard to the instruction to terminate the processing, notification is used which indicates that the panoramic playback mode is released, but there is no particular limitation thereto.

Therefore, in the present embodiment, when the main control unit 51 is notified that the panoramic playback mode is released, YES is determined in step S55, and the entire panoramic playback processing ends.

On the other hand, if the panoramic playback mode is not released, NO is determined in step S55, control goes back to step S52, and the processes thereafter are repeated. This means that, in the present embodiment, as long as the panoramic playback mode is maintained, the loop processing from steps S52 to S55: NO is repeated.

With this, each time the user rotates the digital camera 1 and changes the current direction of his or her eyes, the display content of the display unit 19 is updated, and thereby the captured image of the scenery that has existed in the same orientation as the current orientation of the user's eyes at the capturing location of the panoramic image is displayed.

Thus, by carrying out the panoramic playback processing, it becomes possible to play back a panoramic image that reproduces the scenery viewed at the time when the panoramic image was captured.

As described above, the digital camera 1 of the present embodiment is provided with an image processing unit 17, a main control unit 51, an image composition unit 52, and an image playback unit 53.

The main control unit 51 acquires current orientation data indicative of the current orientation of the digital camera 1.

The image playback unit 53 extracts image data of a partial area corresponding to the current orientation from image data of a panoramic image based on the index orientation data associated with the image data of the panoramic image and the current orientation data acquired by the main control unit 51.

The image playback unit 53 executes control to cause the display unit 19 to display the image expressed by the image data of the extracted partial area.

In this way, the partial area of the panoramic image corresponding to the current orientation of the digital camera 1 (the current orientation of the user's eyes) is displayed.

This means that it is possible to virtually display scenery that has existed in the same orientation as the current orientation of the digital camera 1 (the current orientation of the user's eyes) from among scenery that spreads out three-dimensionally g at the capturing location of the panoramic image. In this way, it becomes possible for the user to view the panoramic image with a sense that the scenery would exist at a place where the panoramic image was captured.

It should be noted that the present invention is not limited to the embodiment described above, and any modifications and improvements thereto within a scope in which an object of the present invention can be realized, are included in the invention.

For example, in the embodiment above, it has been described that image data of a panoramic image is played back in association with orientation data indicative of the orientation at the time of capturing. However, the playback target is not limited to this.

For example, in the embodiment above, it has been described that image data of a playback target panoramic image is image data of a panoramic image generated by combining image data of frames which have been captured while the image capturing device is being swung in a horizontal direction. However, the target to be played back is not limited to this.

The present invention is also applicable to the case of playing back data of a panoramic image generated by combining image data of frames captured while the image capturing device is being swung in a tilt direction (vertical direction).

In this case, the digital camera 1 may include a sensor that can detect a tilt angle each time when image data of each constituent frame of a panoramic image is captured, and record the image data of each frame of the panoramic image in association with tilt angle data indicative of the detected tilt angle at the time of capturing. Also, at the time of playback, it becomes possible to display a partial area corresponding to the current tilt angle of the digital camera 1.

Furthermore, in the embodiment described above, it has been described that the playback apparatus according to the present invention is configured by a digital camera.

However, the present invention is not limited to this and can be applied to any electronic device having an image capture function capable of capturing a panoramic image. For example, the present invention can be applied to a portable personal computer, a portable navigation device, a portable game device, and the like.

The series of processing described above can be executed by hardware and also can be executed by software.

In a case in which the series of processing is to be executed by software, the program configuring the software is installed from a network or a storage medium in a playback apparatus or a computer that controls the playback apparatus. The computer may be a computer incorporated in dedicated hardware. Alternatively, the computer may be a computer capable of executing various functions by installing various programs, i.e., a general-purpose personal computer, for example.

The storage medium containing the program can be configured not only by the removable media 31 distributed separately from the device main body for supplying the program to a user, but also by a storage medium or the like supplied to the user in a state incorporated in the device main body in advance. The removable media 31 is composed of a magnetic disk (including a floppy disk), an optical disk, a magnetic optical disk, or the like, for example. The storage medium supplied to the user in the state incorporated in the device main body in advance includes the ROM 12 storing the program, a hard disk included in the storing unit 18, and the like, for example.

It should be noted that, in the present description, the step describing the program stored in the storage medium includes not only the processing executed in a time series following this order, but also includes processing executed in parallel or individually, which is not necessarily executed in a time series.

What is claimed is:

1. An image playback apparatus, comprising:
a recording unit that records data of a panoramic image in association with orientation data indicative of shooting direction at a time of image capturing;
an orientation acquiring unit that acquires orientation data indicative of the direction of the image playback apparatus; and
a playback unit that plays back a partial area of the panoramic image corresponding to the orientation data of the image playback apparatus, based on the orientation data in association with the panoramic image recorded by the recording unit, and the orientation data acquired by the orientation acquiring unit.

2. An image playback apparatus as set forth in claim 1, further comprising a comparison unit that compares orientation data in association with the panoramic image and orientation data acquired by the orientation acquiring unit, wherein
the playback unit plays back and displays the partial area of the panoramic image having orientation data closest to the orientation data of the image playback apparatus based on a comparison result made by the comparison unit.

3. An image playback apparatus, as set forth in claim 1, wherein
the panoramic image is an image generated from a plurality of images including at least one image in association with orientation data indicative of shooting direction at a time of image capturing.

4. An image playback apparatus, as set forth in claim 2, wherein
the playback unit plays back and displays the partial area corresponding to the orientation data acquired by the orientation acquiring unit from the panoramic image, based on orientation data of any image among a plurality of images included in the panoramic image.

5. An image playback apparatus, comprising:
a recording unit that records a panoramic image in association with angle data indicative of a tilt angle at a time of image capturing;
an angle acquiring unit that acquires angle data indicative of a tilt angle of the image playback apparatus; and
a playback unit that plays back the partial area of the panoramic image corresponding to the angle data of the image playback apparatus, based on the angle data in association with an image constituting the panoramic image recorded by the recording unit, and the angle data acquired by the angle acquiring unit.

6. An image playback apparatus as set forth in claim 5, further comprising a comparison unit that compares angle data in association with the panoramic image and angle data acquired by the angle acquiring unit, wherein
the playback unit plays back and displays the partial area of the panoramic image having angle data closest to the angle data of the image playback apparatus based on a comparison result made by the comparison unit.

7. An image playback apparatus as set forth in claim 5, wherein
the panoramic image is an image generated from a plurality of images including at least one image in association with angle data indicative of a tilt angle at a time of image capturing.

8. An image playback apparatus as set forth in claim 6, wherein
the playback unit plays back the partial area corresponding to the angle data acquired by the angle acquiring unit from the panoramic image, based on angle data of any image among a plurality of images included in the panoramic image.

9. An image playback method of a playback apparatus having a recording unit that records data of a panoramic image in association with orientation data indicative of shooting direction at a time of image capturing, comprising:
an orientation acquiring step of acquiring orientation data indicative of the direction of the playback apparatus; and
a playback step of playing back and displaying a partial area of the panoramic image corresponding to the orientation data of the playback apparatus, based on the orientation data in association with the panoramic image, and the orientation data acquired by the orientation acquiring step.

10. An image playback method of a playback apparatus having a recording unit that records data of a panoramic image in association with angle data indicative of a tilt angle at a time of image capturing;
an angle acquiring step of acquiring angle data indicative of a tilt angle of the playback apparatus; and
a playback step of playing back a partial area of the panoramic image corresponding to the angle data of the playback apparatus, based on the angle data in association with an image constituting the panoramic image recorded in the recording unit, and the angle data acquired in the angle acquiring step.

11. A computer readable storage medium having stored therein a program executable by a computer that controls a playback apparatus including a recording unit that records data of a panoramic image in association with an orientation data indicative of an shooting direction at a time of image capturing, to function as:
an orientation acquiring unit that acquires orientation data indicative of the playback apparatus; and
a playback unit that plays back a partial area of the panoramic image corresponding to the orientation data of the playback apparatus, based on the orientation data in association with the panoramic image recorded in the recording unit, and the orientation data acquired by the orientation acquiring unit.

12. A computer readable storage medium having stored therein a program executable by a computer that controls a playback apparatus including a recording unit that records a panoramic image in association with angle data indicative of a tilt angle at a time of capturing;
an angle acquiring unit that acquires angle data indicative of a tilt angle of the playback apparatus; and
a playback unit that plays back a partial area of the panoramic image corresponding to the angle data of the playback apparatus, based on the angle data in association with an image constituting the panoramic image recorded in the recording unit, and the angle data acquired by the angle acquiring unit.
